(19) United States
(12) Patent Application Publication
(10) Pub. No.: US 2023/0261964 A1
(43) Pub. Date: Aug. 17, 2023

(54) DEVICE, METHOD, SYSTEM AND PROGRAM FOR DETERMINING THE ROUTER TO COLLECT TRAFFIC DATA

(71) Applicant: NIPPON TELEGRAPH AND TELEPHONE CORPORATION, Tokyo (JP)

(72) Inventors: Erina TAKESHITA, Musashino-shi, Tokyo (JP); Shinichi YOSHIHARA, Musashino-shi, Tokyo (JP); Hideaki KIMURA, Musashino-shi, Tokyo (JP)

(73) Assignee: NIPPON TELEGRAPH AND TELEPHONE CORPORATION, Tokyo (JP)

(21) Appl. No.: 18/012,271

(22) PCT Filed: Jun. 29, 2020
(86) PCT No.: PCT/JP2020/025474

§ 371 Date: Dec. 22, 2022

(51) Int. Cl. H04L 45/02; H04L 43/02

(52) U.S. Cl. CPC H04L 45/02; H04L 43/02

(57) ABSTRACT

It is an object of the present disclosure to efficiently collect traffic data on all paths in a network from a transfer device and thus to reduce a collection load.

The present disclosure provides an apparatus that refers to a route database storing route information on paths formed in a network and solves an optimization problem based on the route database so that traffic data on all the paths formed in the network are obtainable and a number of collection target transfer devices from which the traffic data are to be collected is reduced, thus determining, from among a plurality of the transfer devices constituting the network, the collection target transfer devices from which the traffic data are to be collected.

### TECHNICAL FIELD

The present disclosure relates to traffic data collection in a network.

### BACKGROUND ART

Recent years have seen the use of a technique, such as telemetry, for collecting network traffic data or the like (see, for example, Non-Patent Literature 1). The expansion of networks, however, has led to a problem that collecting information on traffic data related to all paths in a network from all transfer devices constituting the network also increases a collection load on a collection device.

### CITATION LIST

### Non-Patent Literature

Non-Patent Literature 1: H. Song et al., “Network Telemetry Framework,” draft-ietf-opsawg-ntf-03, Apr. 13, 2020. https://tools.ietf.org/html/draft-ietf-opsawg-ntf-03

### SUMMARY OF THE INVENTION

### Technical Problem

It is an object of the present disclosure to determine a collection device so as to efficiently collect traffic data on all paths in a network from a transfer device and thus to reduce a collection load.

### Means for Solving the Problem

An apparatus of the present disclosure is configured to refer to a route database storing route information on paths formed in a network and solve an optimization problem based on the route database so that traffic data on all the paths formed in the network are obtainable and a number of collection target transfer devices from which the traffic data are to be collected is reduced, thus determining, from among a plurality of transfer devices constituting the network, the collection target transfer devices from which the traffic data are to be collected.

A system of the present disclosure is a system including the apparatus according to the present disclosure that is connected to the network, wherein the apparatus collects the traffic data from the collection target transfer devices.

A method of the present disclosure includes steps of an apparatus referring to a route database storing route information on paths formed in a network and the apparatus solving an optimization problem based on the route database so that traffic data on all the paths formed in the network are obtainable and a number of collection target transfer devices from which the traffic data are to be collected is reduced, thus determining, from among a plurality of transfer devices constituting the network, the collection target transfer devices from which the traffic data are to be collected.

A transmission program of the present disclosure is a program for enabling a computer to function as each functional unit included in the apparatus according to the present disclosure and a program for causing the computer to execute steps included in a method executed by the apparatus according to the present disclosure.

### Effects of the Invention

According to the present disclosure, it is possible to efficiently collect traffic data on all paths in a network from the smallest possible number of transfer devices and thus to reduce a collection load on a collection device.

### BRIEF DESCRIPTION OF DRAWINGS

FIG. 1 illustrates an example of a system configuration of the present disclosure.

FIG. 2 illustrates an example of a network configuration of the present disclosure.

FIG. 3 shows an outline of the present disclosure.

FIG. 4 shows an example of a hardware configuration of a control apparatus.

FIG. 5 illustrates a configuration example of the control apparatus of the present disclosure.

FIG. 6 shows an example of route information.

FIG. 7 shows an example of a combination of collection targets.

FIG. 8 shows on which paths data can be obtained at the collection targets, respectively.

FIG. 9 is a diagram explaining a collection timing.

### DESCRIPTION OF EMBODIMENTS

With reference to the appended drawings, the following describes embodiments of the present disclosure in detail. The present disclosure, however, is not limited to the embodiments described below. Examples shown in these embodiments are illustrative only, and based on knowledge of those skilled in the art, the present disclosure can be implemented in variously modified or improved forms. Constituent elements denoted by identical reference signs in the specification and drawings of the present disclosure shall indicate mutually identical elements.

### Descriptions of Terms

Collection Device

A collection device is a device that collects, for the purpose of bandwidth designing, traffic data such as a traffic counter value from a transfer device in a network and uses a collection technique, such as telemetry, for collecting data at short intervals and with fine granularity. In the present disclosure, the transfer device functions as the collection device.

Transfer Device

A transfer device is a device that is a constituent component of a network and transfers data.

Path

Data for point-to-point communication are transferred along paths formed in a network.

gRPC (Google Remote Procedure Call)

The gRPC is a technique for transfer between a router and a collection server and enables multiplexing of a plurality of Hypertext Transfer Protocol (HTTP) requests by using a single Transmission Control Protocol (TCP) connection. In this embodiment, this technique is applicable to a technique for transfer between the transfer device and a control apparatus 10.

(System Configuration)

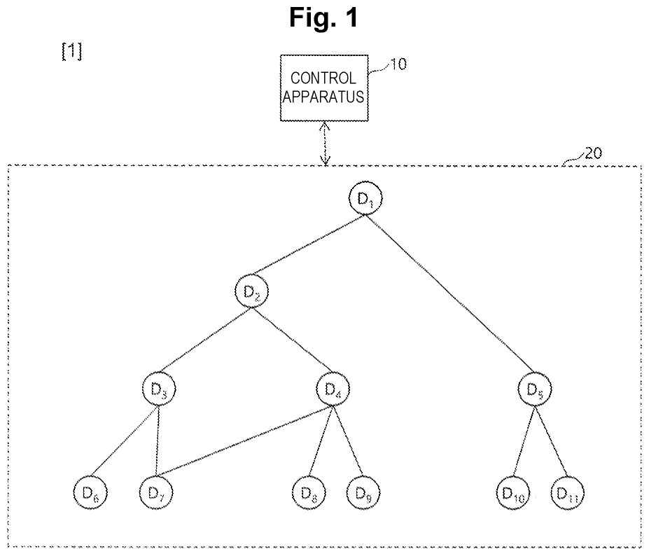

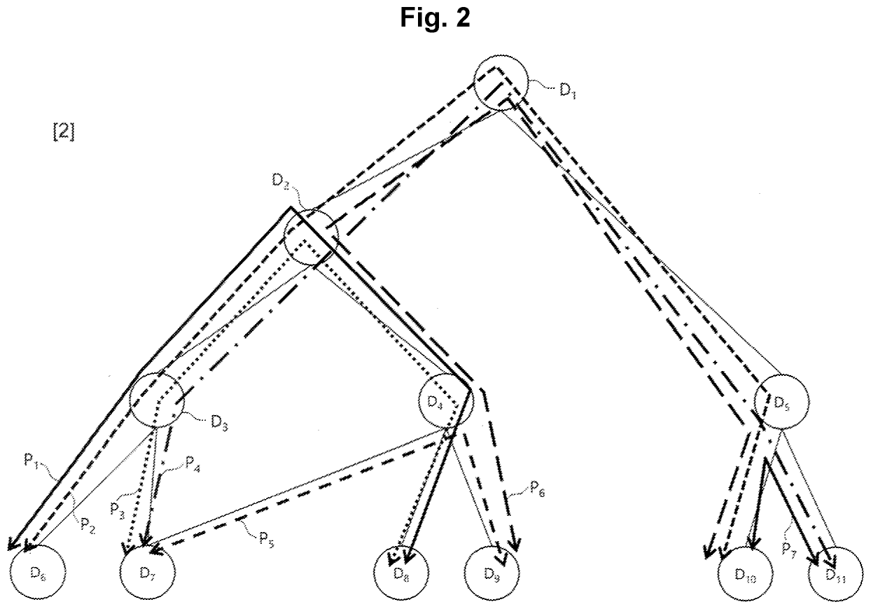

FIG. 1 shows an example of a system configuration of the present disclosure. This system is configured to include a network 20 and the control apparatus 10. The network 20 has no bandwidth limitation and is such a network that route information on paths therein can be always grasped and the traffic data on each of the paths can be obtained at any location in a route thereof. This embodiment shows, as an example of the network, a network including transfer devices D₁ to D₁₁ connected in a tree shape and paths P₁ to P₇ as shown in FIG. 2.

The control apparatus 10 obtains route information on the paths from the network 20 and stores the route information in a route database (hereinafter, may be referred to as DB (database)). Based on the route information, the control apparatus 10 determines a transfer device from which the traffic data are to be collected so that the traffic data can be efficiently collected from the network 20.

(Gist of the Invention)

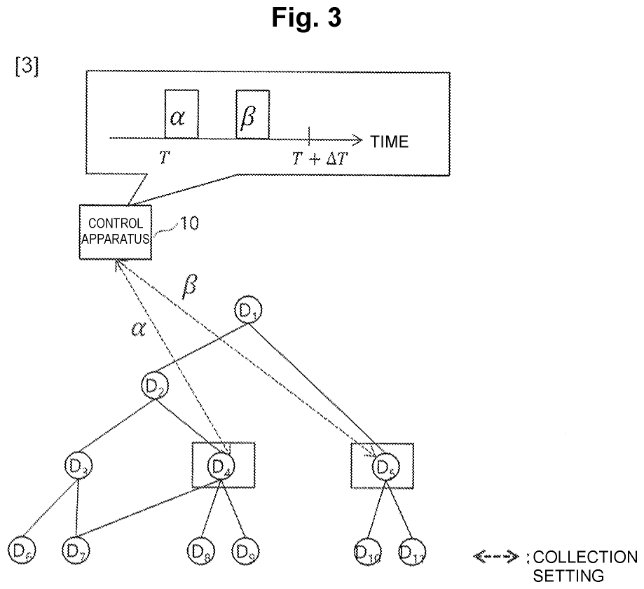

FIG. 3 shows an outline of the present disclosure. The present disclosure is to determine a transfer device from which the traffic data are to be collected so that the traffic data are efficiently collected from the smallest possible number of transfer devices.
It is determined from which the transfer device traffic data are to be collected so that the traffic data on all paths can be collected and the traffic data are collected from the smallest possible number of transfer devices (a function A). For example, transfer devices D₄ and D₅ are determined as the transfer devices from which the traffic data are to be collected.
A timing for collection from each transfer device is determined so that cycles of collection therefrom are asynchronous among the transfer devices (a function B). For example, respective timings for collection from the transfer devices D₄ and D₅ are determined so that the timing for collection from the transfer device D₄ is asynchronous with the timing for collection from the transfer device D₅.

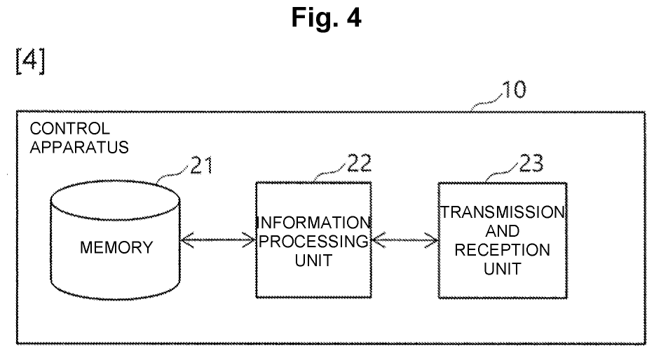

FIG. 4 shows an example of a hardware configuration of a control apparatus. The control apparatus 10 includes a memory 21, an information processing unit 22, and a transmission and reception unit 23. The information processing unit 22 is equipped with a function as a collection device and the function A and the function B. The control apparatus 10 can also be formed of a computer and a program and is capable of both recording the program on a recording medium and providing the program via a network. For example, the functions A and B may be achieved by causing the computer to execute the program.

The transmission and reception unit 23 obtains route information in the network 20 and stores the route information in the memory 21. The route information in the network 20 is obtained by any method such as, for example, a method in which link destinations of the transfer devices D₁ to D₁₁ are obtained from the transfer devices D₁ to D₁₁, respectively.

The information processing unit 22 determines a collection target transfer device (the function A) and determines a timing for collection therefrom (the function B). The transmission and reception unit 23 notifies the collection target transfer device of the collection timing.

The collection target transfer device functions as a collection device and transmits pieces of traffic data passing therethrough to the control apparatus 10 at the collection timing notified from the control apparatus 10.

The transmission and reception unit 23 receives the pieces of traffic data from the collection target transfer device and stores them in the memory 21. Thus, the system of the present disclosure enables collection of the traffic data on all paths in the network 20.

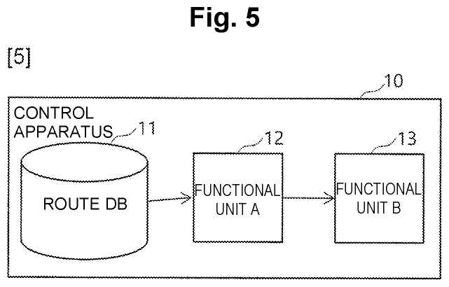

FIG. 5 shows a configuration example of the control apparatus of the present disclosure. The control apparatus 10 of the present disclosure includes a route DB 11, a functional unit A 12, and a functional unit B 13. The route DB 11 stores route information indicating through which the transfer device, from among the transfer devices D₁ to D₁₁, each of paths P₁ to P₇ passes.

(Functional Unit A)

The functional unit A 12 has a function of determining, based on the route DB 11, a collection target transfer device so that the traffic data on all paths can be obtained and the number of the collection target transfer devices is reduced.

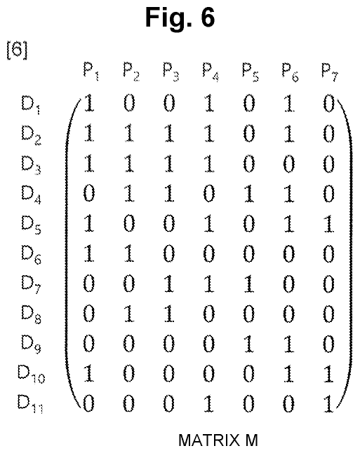

FIG. 6 shows an example of route information stored in the route DB. A matrix M represents an example of the route information retained by the route DB, in which rows correspond to the transfer devices D₁ to D₁₁ and columns correspond to the paths P₁ to P₇. Each element m_{i,j} has a value of 1 when a path P₁ passes through a transfer device Dᵢ and a value of 0 when the path Pⱼ does not pass therethrough. This problem is formulated as an optimization problem below.

$$[ Math . 1 ]$$

$$arg {min}_{I} \vert I \vert , {\sum }_{i ∈ I} {m}_{i , j} \geq 1 , ∀ j ∈ J \qquad ( 1 )$$

where I denotes a combination of row vectors.

In any j included in J,

$$[ Math . 2 ]$$

$${\sum }_{i ∈ I} {m}_{i , j} \geq 1 \qquad ( 2 )$$

is satisfied by a combination of elements i as a set I, and such a combination I that the number of the elements i is minimum is found. In this case, j components are row vectors in the combination, and at least one of them is 1.

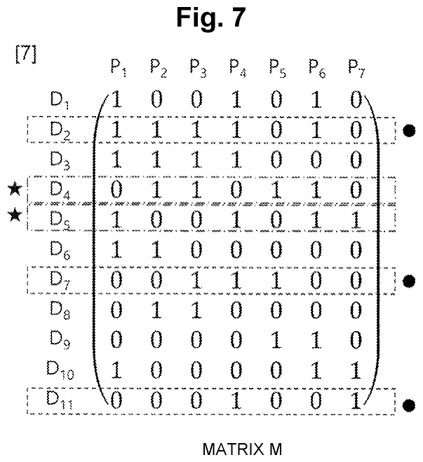

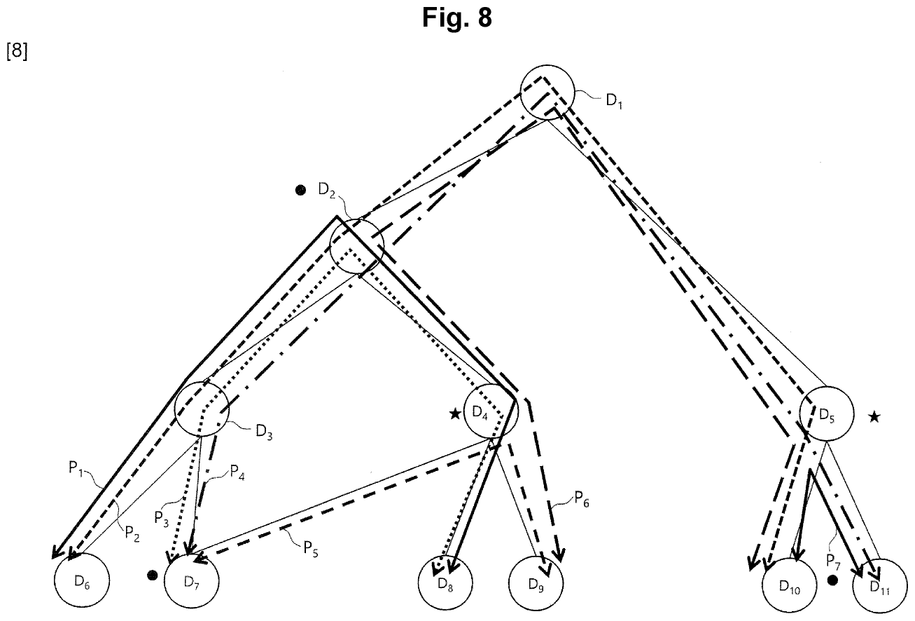

When the transfer device D₂ through which a highest number of paths pass is first selected as a collection target transfer device, it is necessary to obtain information on the path P₅ and the path P₇ as shown in FIG. 7. It is, therefore, necessary to select the transfer devices D₇ and D₁₁ as collection targets, in which the combination I is composed of the transfer devices D₂, D₇, and D₁₁ (the transfer devices each marked with a solid circle shown in FIG. 7 and FIG. 8).

On the other hand, when the transfer devices D₄ and D₅ (the transfer devices each marked with a solid star shown in FIG. 7 and FIG. 8) are selected, though they are not transfer devices through which a highest number of paths pass, information on all the paths can be collected, and thus the number of collection target transfer devices can be reduced more than that in the previously described example. Since an optimum combination varies depending on a selection method as described above, it is necessary to solve this problem as a combinatorial optimization problem by using an appropriate algorithm (a greedy algorithm or a neighborhood search that is an approximate solution (heuristic)).

(Functional Unit B)

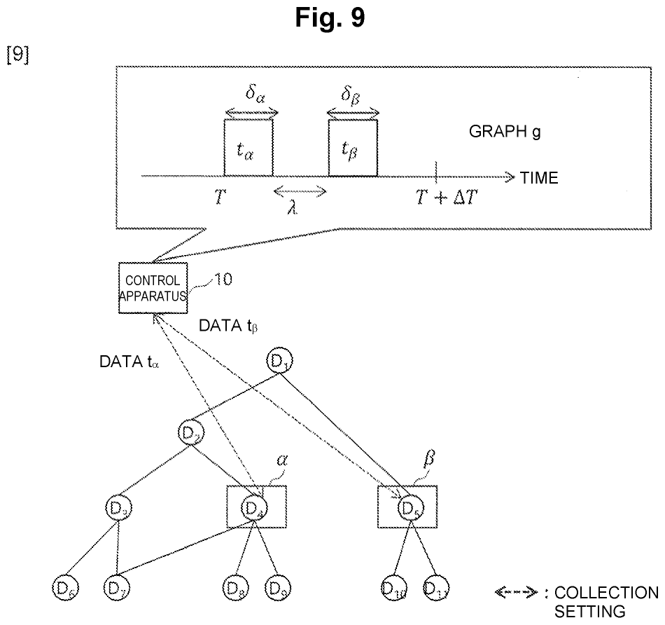

The functional unit B 13 determines a timing for collection from each transfer device determined in the above-described functional unit A so that the collection timing is asynchronous among the transfer devices. A description is given of a specific example with reference to FIG. 9. The functional unit A 12 of the control apparatus 10 has determined a transfer device α and a transfer device β as the transfer devices from which the traffic data t_{α} and the traffic data t_{β} are to be collected, respectively. The functional unit B sets an amount of time ΔT as a collection cycle and sets a timing for collection from each of the transfer device α and the transfer device β between a time T and a time T+ΔT.

An amount of time required for receiving the traffic data t_{α} and an amount of time required for receiving the traffic data t_{β} are denoted as δ_{α} and δ_{β}, respectively. The traffic data t_{β} is set to be received after a lapse of an amount of time λ from the completion of reception of the traffic data t_{α} so that a reception time thereof do not overlap that of the traffic data t_{α}. In this case, however, an inequality 0≤λ≤ΔT−(δ_{α}+δ_{β}) is established. Furthermore, a graph g is a graph showing respective timings at which the traffic data t_{α} and the traffic data t_{β} are collected in the control apparatus 10 within the time ΔT.

(Effects Provided by the Invention)

The number of requests from the control apparatus 10 to the transfer devices is reduced (the functional unit A), and also an occurrence of requests from a multitude of transfer devices to the control apparatus 10 at one time is prevented (the functional unit B), so that a load on the control apparatus 10 can be reduced.

### INDUSTRIAL APPLICABILITY

This disclosure is applicable to the information and communication industry.

### REFERENCE SIGNS LIST

10 control apparatus
11 route database
12 functional unit A
13 functional unit B
21 memory
22 information processing unit
23 transmission and reception unit

1. An apparatus configured to:
refer to a route database storing route information on paths formed in a network; and
solve an optimization problem based on the route database so that traffic data on all the paths formed in the network are obtainable and a number of collection target transfer devices from which the traffic data are to be collected is reduced, thus determining, from among a plurality of transfer devices constituting the network, the collection target transfer devices from which the traffic data are to be collected.

2. The apparatus according to claim 1, wherein
a timing for collecting the traffic data from each of the plurality of the collection target transfer devices is determined so as to be asynchronous among the collection target transfer devices.

3. A system, comprising:
the apparatus according to claim 1 that is connected to the network, wherein
the apparatus collects the traffic data from the collection target transfer devices.

4. A method, comprising steps of:
an apparatus referring to a route database storing route information on paths formed in a network; and
the apparatus solving an optimization problem based on the route database so that traffic data on all the paths formed in the network are obtainable and a number of collection target transfer devices from which the traffic data are to be collected is reduced, thus determining, from among a plurality of the transfer devices constituting the network, the collection target transfer devices from which the traffic data are to be collected.

5. A non-transitory computer-readable medium having computer-executable instructions that, upon execution of the instructions by a processor of a computer, cause the computer to function as the apparatus according to claim 1.
